(19) United States
(12) Patent Application Publication
(10) Pub. No.: US 2003/0000759 A1
(43) Pub. Date: Jan. 2, 2003

(54) Device and method for supplying electrical power to a motor vehicle

(76) Inventors: Peter Schmitz, Aachen (DE); Rainer Busch, Aachen (DE); Uwe Gussen, Huertgenwald (DE)

Correspondence Address: Carlos L. Hanze, Ford Global Technologies, Inc., 600 East Parklane Towers, One Parklane Boulevard, Dearborn, MI, 48126, US

(21) Appl. No.: 10/186,538

(22) Filed: Jul. 1, 2002

(30) Foreign Application Priority Data
Jun. 29, 2001 (EP) 01115868.0

(51) Int. Cl. B60K 1/00; B60K 3/00

(52) U.S. Cl. 180/291; 180/65.1

(57) ABSTRACT

A power supply arrangement for a vehicle having an electric motor includes a plurality of high-power batteries which are arranged within the vehicle and are connected to a motor regulator in a series circuit. A switch-off unit ensures that a fixed disconnection sequence is carried out when the motor vehicle is switched off, the motor regulator being first provided with the opportunity of reducing the power drain. Subsequently, a main circuit breaker, which disconnects the connection of the batteries to the outside, is opened first and then further circuit breakers, which are arranged between the batteries, are opened.

### BACKGROUND OF THE INVENTION

1. Field of the Invention

The invention relates to an electrical power supply arrangement for a motor vehicle, having two external terminals for making available a voltage from a voltage source and, a circuit breaker being arranged between a first of the external terminals and the voltage source. In addition, the invention relates to an electric vehicle containing an electric drive motor with a motor regulator and a method for disconnecting a power supply arrangement which is composed of a plurality of batteries connected in series.

2. Background Art

Motor vehicles must generally contain a power supply arrangement to supply the electrical loads. This applies in particular to electric vehicles which, as what are referred to as hybrid vehicles, use an internal combustion engine and an electric motor for the drive or, as pure electric vehicles, use an electric motor alone for the drive. Such electric vehicles which are at least partially driven electrically require a high-power power supply which can make available appropriately high levels of power or current. Owing to their use for the drive of a vehicle, such power supply drives are also referred to as traction batteries.

When an electrical load is connected to and disconnected from an electrical power supply arrangement, specific measures are necessary to avoid damage. These measures can serve, on the one hand, to protect the electrical systems against undesired voltage conditions. It is also necessary to protect the electrical system in the case of an exceptional situation, such as an accident situation. In order to achieve the last-mentioned objective, WO 99/65046 has disclosed an electromechanical circuit breaker which can be connected to a terminal of a battery of a motor vehicle and connects this terminal to the dynamo, on the one hand, and to the vehicle's electrical system for other electrical loads, on the other. Here, the connection to the dynamo can be disconnected, for example, in the case of an accident under the control of a sensor so that a resulting risk is reduced while at the same time the functioning of “non-hazardous” electrical loads can be maintained.

A similar system is known from U.S. Pat. No. 5,818,122 in which only a primary circuit is disconnected in the case of an accident while the functioning of other systems is maintained. However, the known systems do not take into account the situation which typically occurs with electrically driven vehicles that the power supply arrangement is composed of at least two batteries which are spatially separated from one another and from which a high level of power is drawn.

### SUMMARY OF THE INVENTION

Against this background, an advantage of the present invention is to make available a device and a method for protecting the electrical power supply in a vehicle, in particular in a vehicle having an electric drive.

The electrical power supply arrangement for a motor vehicle, which is suitable in particular for an at least partially electrically driven motor vehicle, contains two external terminals for making available a voltage from a voltage source to a load, a circuit breaker being arranged between a first of the two external terminals and the voltage source. The power supply arrangement is characterized in that the voltage source is composed of at least two batteries connected in series, and in that at least one further circuit breaker is arranged between the batteries and/or between the second of the two external terminals and the batteries.

As a result of the use of at least two batteries which are preferably arranged spatially separated from one another in the vehicle, the aforesaid power supply arrangement is particularly suitable for making available high levels of power which are typically necessary for an electric drive. The protection of such a system is ensured in the case of connection and disconnection and in an exceptional situation (accident) by means of a plurality of circuit breakers. Circuit breakers arranged between the external terminals and the batteries ensure that the loads distributed in the vehicle are disconnected from the power supply. Furthermore, the connections which connect the batteries to one another in series can also be disconnected by means of circuit breakers.

In accordance to a preferred embodiment, the power supply arrangement includes at least three batteries, the first battery being arranged in the motor/engine compartment, the second battery being arranged in front of the rear axle of the motor vehicle and the third battery being arranged behind the rear axle of the motor vehicle. In particular in electrically driven motor vehicles, a plurality of batteries are provided in order to make available the necessary high level of power, the batteries being arranged distributed in the motor vehicle for, inter alia, static reasons. When there is a distributed accommodation of the power supply arrangement in the vehicle in this way, connecting lines which run over relatively large distances through the vehicle must inevitably be laid between the batteries. When there are such long connecting lines, the proposed embodiment of the power supply arrangement features connecting lines that can be disconnected from the voltage as a result of the activation of circuit breakers arranged therein.

With the division of the power supply arrangement into at least three batteries as just mentioned, the batteries are preferably connected in series in the sequence first battery (in the motor/engine compartment), third battery (behind the rear axle) and second battery (between the first and third battery), as a result of which the maximum length of a through-going connecting line can be limited. In addition, with this configuration, a circuit breaker is preferably arranged between the first external terminal and the first battery, a circuit breaker is preferably arranged between the second external terminal and the second battery and two circuit breakers are preferably arranged in the connection between the first and third batteries. The circuit breakers just mentioned are each arranged near to the first or third battery in this context with the result that when they open the connecting line can be disconnected from the voltage virtually over its entire length.

According to another embodiment of the power supply arrangement, it has, in addition to the external terminals already present, two further external terminals between which the batteries of the power supply arrangement can be connected in series without the interconnection of circuit breakers. Voltage can thus be continuously tapped from the batteries at the two further external terminals so that these terminals are suitable, in particular, for supplying loads whose function is to be maintained even in an exceptional situation. These loads are typically those which are not associated with the electrical drive of the vehicle and therefore only require a low level of power.

The invention also relates to a vehicle having an electric drive motor with a motor regulator, the motor regulator feeding electrical power to the drive motor depending on the driving situation and requirements. In particular, the motor regulator can also convert DC voltage into AC voltage. The electric vehicle is characterized in that the motor regulator is connected to a power supply arrangement of the type explained above. That is to say the power supply arrangement contains at least two batteries, and that circuit breakers are arranged between these batteries and/or between the batteries and the external terminals of the power supply arrangement which are coupled to the motor regulator.

The vehicle preferably has a switch-off unit which is connected to the motor regulator and to the circuit breakers of the power supply arrangement and is designed in such a way that after it has been triggered it firstly causes the motor regulator to reduce the power drain from the power supply arrangement, and that it subsequently opens the circuit breakers of the power supply arrangement. Such a switch-off unit can react in particular to the parking of the motor vehicle (removal of the ignition key) which generally takes place at the end of a period of use of the vehicle. However, it is also possible to react furthermore to exceptional situations such as for example an accident. In such a case, firstly it is attempted, by actuating the motor regulator, to reduce the power drain as far as possible or even return it entirely to zero in order to make the flow of current in the lines as small as possible. When such a reduction of the flow of current has been attempted, the circuit breakers are then opened, this interruption being able to take place when currents have already been reduced.

According to another aspect of the invention, the switch-off unit can also be designed in such a way that it firstly opens a circuit breaker located between an external terminal of the power supply arrangement and the voltage source of the power supply arrangement, and that it subsequently opens the remaining circuit breakers of the power supply arrangement. As a result of this sequence of the opening of the circuit breakers it is possible to ensure that when the switches open no configurations are produced which could lead to undesired operation of the power supply arrangement or loads.

According to another embodiment of the switch-off unit, it can have an inertia switch which is coupled to the motor regulator and the input end of a first relay and is designed in such a way that when acceleration occurs above a predefined threshold, it opens a circuit and as a result transmits a signal to the motor regulator and opens the first relay after a delay. The first relay is coupled at the output end to a first circuit breaker of the power supply arrangement and to the input end of a second relay in such a way that the opening of the first relay opens the aforesaid first circuit breaker and the second relay after a delay. The second relay is coupled at the output end to the other circuit breakers of the power supply arrangement and is designed in such a way that the opening of the relay brings about the opening of the aforesaid circuit breakers. As a result of such an embodiment of the switch-off unit with an inertia switch and two coupled relays it is possible to detect an accident owing to the high braking accelerations which are associated with it and, in reaction thereto, to actuate in chronological sequence firstly the motor regulator, then a first circuit breaker and finally the other circuit breakers.

The invention finally also relates to a method for disconnecting a power supply arrangement for a motor vehicle which is composed of a plurality of batteries connected in series, which is characterized in that firstly the connection between an external terminal of the power supply arrangement and a first battery is opened, and in that further connections in the series circuit of the batteries are opened after a delay. Such a method ensures that firstly the connection of the power supply arrangement to the outside is disconnected before switching operations are performed within the power supply arrangement (between the batteries). Because completely simultaneous opening of switches can never be realized, the stipulation of the aforesaid sequence ensures that no undesired configuration can occur when all the circuit breakers open.

### BRIEF DESCRIPTION OF THE DRAWINGS

The invention is explained in more detail below by way of example with reference to the figures, of which

FIG. 1 shows a schematic view of the components of a motor vehicle with a power supply arrangement according to the invention, and

FIG. 2 shows a schematic view of the design of a switch-off unit for the power supply arrangement according to FIG. 1.

### DETAILED DESCRIPTION OF THE PREFERRED EMBODIMENTS

The exemplary embodiment illustrated in the figures relates to an electric vehicle with an electric motor 2 which drives the drive wheels 1 of the vehicle. The motor 2 is supplied with a suitable AC voltage (AC) from a motor regulator 3. The motor regulator 3 itself draws the required electrical power as DC voltage (DC) from a power supply arrangement 14 which is configured in the way according to the invention which is explained in more detail below. Instead of the single drive by means of the electric motor 2, in a hybrid constellation the electric motor could also drive the motor vehicle together with an internal combustion engine.

The power supply arrangement 14 contains three batteries 5a, 5b, 5c, which may be in particular special lithium ion high-power batteries. Owing to their size and their weight, such batteries are typically accommodated distributed in the vehicle. For example, the first battery 5a is located together with the electric motor 1 and the motor regulator 3 in the motor/engine compartment, the second battery 5b is located directly in front of the rear axle 13 and the third battery 5c is located behind the rear axle 13 of the vehicle. The batteries are typically accommodated here in what are referred to as battery troughs. The spatially distributed arrangement of the batteries requires them to be connected to one another via extended cabling in a series circuit, the D.C. voltage of the batteries which are connected in series being made available at two external terminals 4a, 4b which lead to the motor regulator 3.

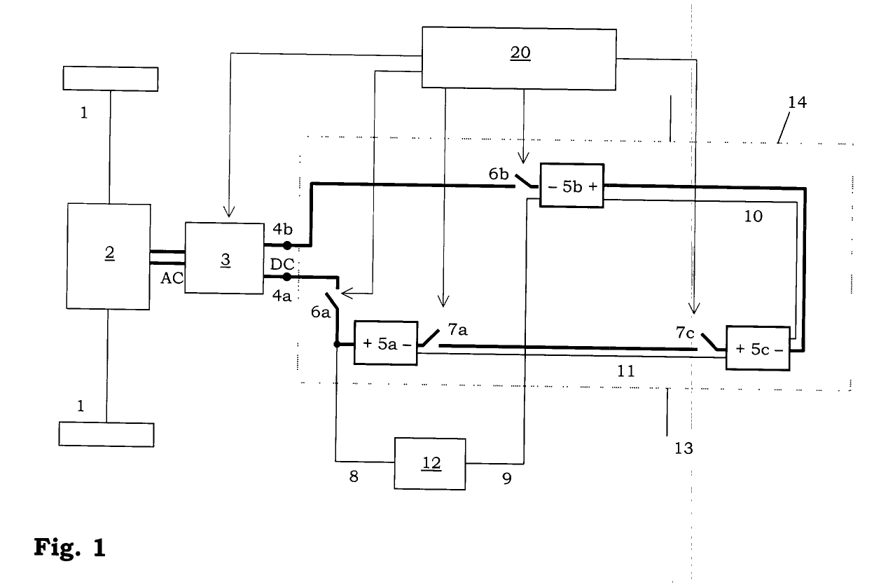

The individual batteries must be disconnected from the vehicle when it is switched off (ignition key withdrawn) or if an exceptional situation such as for example an accident occurs. In order to ensure this, high-power circuit breakers are inserted into the connecting lines at the locations illustrated in FIG. 1 between the batteries and the external terminals. In particular, a circuit breaker 6a is located between a first external terminal 4a and the first battery 5a, a circuit breaker 7a is located in the vicinity of the first battery 5a in the connecting line between the first battery 5a and the third battery 5c, a further circuit breaker 7c is located in the vicinity of the third battery 5cin the connecting line which has already been mentioned between the first battery 5a and the third battery 5c and a third circuit breaker 6b is located in the vicinity of the second battery 5b in the line between this second battery 5b and the second external terminal 4b.

If all the aforesaid circuit breakers 6a, 6b, 7a, 7c are opened, current-conducting lines in the vehicle are interrupted. In particular, the external terminals 4a, 4b which are connected to the motor regulator and the motor are completely disconnected from the power supply arrangement 14. Furthermore, it is ensured that the connecting line which extends over relatively large distances through the vehicle between the first battery 5a and the third battery 5c is disconnected at both ends from the batteries by the circuit breakers 7a, 7c. On the other hand, it is possible to dispense with a circuit breaker in the connecting line between the third battery 5c and the second battery 5b because the length of this line is comparatively short. The saving in terms of circuit breakers in this line correspondingly reduces the expenditure on control, the consumption of power and the installation costs. If such aspects play a less significant role, it is, however, also possible to arrange at least one circuit breaker in the connection between the batteries 5c and 5b.

In addition to the previously described “high-power connecting lines” of the batteries 5a, 5b, 5c to the motor regulator 3 (in bold in FIG. 1), there is also a second power system or a “low-power bus” which makes available a high voltage access to the batteries 5a, 5b, 5c for a vehicle's electrical system 12. This low-power bus includes a series circuit of the batteries 5a, 5c and 5b via the respective bus lines 8, 9, 10 and 11. The aforesaid lines have a comparatively small diameter because typically a maximum of 50 mA is drawn via them, whereas up to 300 A can be drawn via the high-power lines.

While the vehicle is traveling, all the circuit breakers 6a, 6b, 7a, 7c are closed so that current can be drawn from the power supply arrangement 14 by the motor regulator 3. This flow of current must be interrupted in the case of an accident in order to exclude the risk from current-conducting lines within the vehicle. Such disconnection of the power supply 14 is basically possible by opening all the circuit breakers 6a, 6b, 7a, 7c. However, it is to be noted that in practice the circuit breakers cannot all be opened simultaneously because random and unpredictable delays can always occur. If it was therefore attempted to cause all the circuit breakers to open simultaneously, an intermediate situation could occur, for example, in which the circuit breakers 6a and 6b are still closed while the circuit breakers 7a and 7c have already opened.

In order to avoid such situations, according to the invention compliance with the following sequence during disconnection of the power supply arrangement 14 is proposed:

i. firstly, in the case of an accident, the motor regulator 3 is provided with the opportunity to reduce the power drain as far as possible.

ii. Then, after a predetermined period of time after the detection of the accident, the main circuit breaker 6a is opened so that the circuit of the batteries 5a, 5b, 5c is disconnected from the outside.

iii. Lastly, the other circuit breakers 7a, 7c and 6b are opened in order to disconnect all the connections of the batteries 5a, 5b, 5c to the vehicle.

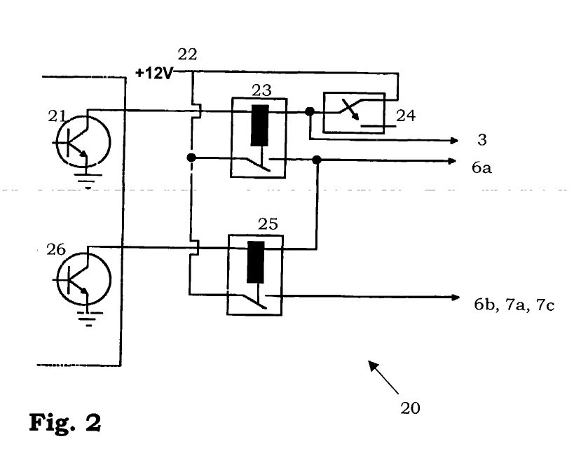

The aforesaid sequence of the disconnection of the power supply from the vehicle is preferably ensured by a switch-off unit 20 in a redundant fashion in order to ensure the greatest possible degree of protection against failures. In particular, the switch-off sequence can be achieved, on the one hand, by software control and, on the other hand, by means of a hardware switching operation. In a possible switch-off unit 20 according to FIG. 2, the input end of a first relay 23 is connected, on the one hand, to a supply voltage 22 (12 volts) via an inertia switch 24 and on the other hand to ground via a transistor 21. In the normal, closed state of the inertia switch 24, there is thus a flow of current through the primary side of the relay 23, as a result of which this relay brings about, at the output end, a current connection between the supply voltage 22 and the coils of the main circuit breaker 6a, which leads to the main circuit breaker 6a closing.

Furthermore, when the output circuit of the first relay 23 is closed, the input circuit of a second relay 25 is connected, on the one hand, to the supply voltage 22 and on the other hand to ground via a transistor 26. The second relay 25 is thus also in the activated state in which it closes, in its output circuit, a connection of the coils in the circuit breakers 6b, 7a and 7c to the voltage supply 22. These circuit breakers are therefore also in a closed state.

The inertia switch 24 opens if it detects that a specific braking acceleration is exceeded. Such switches are typically a component of motor vehicles in order to switch off the fuel pump in the case of an accident. When the inertia switch 24 opens, it results in the connection of the motor regulator 3 to the supply voltage 22 being immediately interrupted. The motor regulator 3 then attempts to reduce the power drain from the power supply arrangement 14 (FIG. 1) to zero. A certain time, predefined by the system properties, later, the first relay 23 opens its output circuit because the input circuit has been de-energized by the opening of the inertia switch 24. As a result of the opening of the first relay 23, the coil of the main circuit breaker 6a becomes de-energized, after which the main circuit breaker 6a opens. Furthermore, the opening of the first relay 23 leads to an interruption of the power supply of the input circuit of the second relay 25. This leads in turn, after a delay time predefined by system parameters, to opening of the output circuit of the second relay 25, as a result of which the power supply of the coils in the circuit breakers 6b, 7a and 7c is interrupted. In reaction to this, the aforesaid circuit breakers then open.

The circuit according to FIG. 2 thus constitutes a hardware solution which, in the case of an accident, firstly actuates the motor regulator in a desired fashion in a chronologically predefined sequence and then successively opens the main circuit breaker 6a and the other circuit breakers 6b, 7a, 7c.

The explained effects of opening the inertia switch 24 are preferably also triggered when the motor vehicle is switched off (power off), for example as a result of a further switch (not illustrated) between the voltage supply 22 and the first relay 23. As a result of the switch-off sequence which is triggered as a result of this, the batteries are protected against transient current pulses and the vehicle is protected, for example, for service work on the high-voltage system.

Although the present invention has been described in connection with particular embodiments thereof, it is to be understood that various modifications, alterations and adaptations may be made by those skilled in the art without departing from the spirit and scope of the invention. It is intended that the invention be limited only by the appended claims.

What is claimed:

1. An electrical power supply arrangement for a motor vehicle, comprising:
a voltage source having two external terminals for making available a voltage from said voltage source, said voltage source is comprising at least two batteries connected in series;
a first circuit breaker being arranged between a first of the external terminals and the voltage source, and
at least a second circuit breaker arranged between said batteries.

2. The power supply arrangement according to claim 1, wherein said second circuit breaker is arranged between said second external terminal and said batteries.

3. The power supply arrangement according to claim 1, wherein said second circuit breaker is arranged between said batteries and between said second external terminal and said batteries.

4. The power supply arrangement according to claim 1, comprising three batteries, the first battery being arranged in the motor/engine compartment, the second battery being arranged in front of the rear axle and the third battery being arranged behind the rear axle of the motor vehicle.

5. The power supply arrangement according to claim 5, wherein said batteries are connected in series in the sequence first battery, third battery and second battery, and wherein in each case one circuit breaker is arranged between the external terminals and the first battery or second battery, and two circuit breakers are arranged in the connection between the first battery and the third battery.

6. The power supply arrangement according to claim 1, further comprising external terminals between which said batteries are connected in series without a circuit breaker.

7. An vehicle containing an electric drive motor and a motor regulator, wherein the motor regulator is coupled to a power supply arrangement as claimed in claim 1.

8. The vehicle according to claim 7, further comprising a switch-off unit which is connected to the motor regulator and to the circuit breakers of the power supply arrangement and operates in such a way that after it has been triggered the switch-off unit firstly causes the motor regulator to reduce the power drain from the power supply arrangement, and that it subsequently opens the circuit breakers of the power supply arrangement.

9. The vehicle according to claim 8, wherein the switch-off unit operates in such a way that it firstly opens a circuit breaker located between an external terminal and the voltage source and subsequently opens the remaining circuit breakers.

10. The vehicle according to claim 8, wherein the switch-off unit has an inertia switch and operates in such a way that when an excessive acceleration occurs the inertia switch opens a circuit and as a result transmits a signal to the motor regulator and opens a first relay after a delay, the opening of the first relay opening a first circuit breaker of the power supply arrangement and a second relay after a delay, the opening of the second relay opening the other circuit breakers of the power supply arrangement.

11. A method for disconnecting a power supply arrangement, having of a plurality of batteries connected in series, from loads in a motor vehicle, comprising: opening a connection between an external terminal of the power supply arrangement and a first battery, and opening connections in the series circuit of the batteries after a delay.
